(19) United States
(12) Patent Application Publication
(10) Pub. No.: US 2015/0319787 A1
(43) Pub. Date: Nov. 5, 2015

(54) SELECTIVELY DECODING PACKET PAYLOADS BASED ON DECODED PACKET HEADERS

(71) Applicant: Alcatel-Lucent USA Inc., Murray Hill, NJ (US)

(72) Inventor: Jonathan Ling, Holmdel, NJ (US)

(73) Assignee: Alcatel-Lucent USA Inc., Murray Hill, NJ (US)

(21) Appl. No.: 14/266,015

(22) Filed: Apr. 30, 2014

(51) Int. Cl. H04W 74/08; H04W 8/00

(52) U.S. Cl. CPC H04W 74/0858; H04W 8/005

(57) ABSTRACT

A wireless communication node selectively decodes a payload of a packet based on a measured signal strength of a decoded header of the packet and a modulation and coding scheme (MCS) used to encode the payload of the packet. In some embodiments, the MCS may be indicated in the decoded header of the packet.

### BACKGROUND

1. Field of the Disclosure

The present disclosure relates generally to wireless communication systems and, more particularly, to decoding packets in wireless communication systems.

2. Description of the Related Art

Wireless communication systems such as Wi-Fi systems are prone to a “hidden node problem,” which arises when two stations are within range of the same access point, but are too far apart to be aware of each other. The two stations are therefore hidden from each other. Access points can also be hidden from each other, leading to a hidden node problem at a station. The hidden node problem can be exacerbated by the presence of obstructions between the stations for the access points. For example, building penetration losses are typically on the order of 11-20 dB. Consequently, an indoor station may be hidden from an outdoor station even though they may be physically proximate to each other. Similarly, two indoor stations may be hidden from each other if they are separated by one or more walls, doors, or other obstructions within the building.

Nodes that are hidden from each other cannot coordinate transmission and reception of packets, e.g., to force time-sharing between the two nodes. Packets transmitted by nodes that are hidden from each other may therefore collide at a receiving node, which can only decode one packet at a time. Consequently, packets intended for the receiving node may be missed or lost if they collide with other packets transmitted by a hidden node. For example, packets transmitted between access points and stations are typically divided into a header and a payload. The 802.11 standard requires that every node must attempt to decode the payload of a packet if it has successfully decoded the header of the packet. A first packet transmitted by a hidden node may therefore cause a receiving node to miss a second packet destined for the receiving node if it previously decoded the header of the first packet transmitted by the hidden node and is therefore occupied attempting to decode the payload of the first packet when the second packet arrives at the receiving node.

This problem may be exacerbated by at least two features of transmitted packets. First, packet headers are encoded using the most reliable rate specified in the modulation and coding scheme (MCS) for packet transmission and packet payloads may be encoded using a variable rate that is determined by the current channel conditions over the air interface. The header can therefore be decoded at much lower signal-to-interference-plus-noise ratios (SINRs) than the payload. For example, in some cases there is at least a 20 dB difference between the header and the payload. A receiving node may therefore be able to decode headers of packets that are received at low signal strength, which increases the likelihood that the receiving node can successfully decode the headers of packets from hidden nodes and consequently increases the likelihood that the receiving node will be required to attempt to decode the packet payloads from hidden nodes. Second, packets that are not intended for a receiving node cannot be easily filtered until the payload is decoded because the destination field, which indicates which node should receive the packet, is typically found in the payload of the packet.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a first example of a wireless communication system according to some embodiments.

FIG. 2 is a plot that illustrates interference between packets received at a receiving node from different transmitting nodes according to some embodiments.

FIG. 3 is a diagram of a second example of a wireless communication system according to some embodiments.

FIG. 4 is a diagram of a third example of a wireless communication system according to some embodiments.

FIG. 5 is a flow diagram of a method for selectively decoding packet payloads at a receiving node according to some embodiments.

FIG. 6 is a diagram of a packet header according to some embodiments.

FIG. 7 is a diagram of a table for storing values of a threshold SINR as a function of an encoding rate (RATE) according to some embodiments.

FIG. 8 is a block diagram of a wireless communication node according to some embodiments.

### DETAILED DESCRIPTION

Packets transmitted by hidden nodes that are not intended for a receiving node can be preferentially filtered out of the packet stream by selectively decoding the payload of a packet based on a measured signal strength of a decoded header of the packet and a modulation and coding scheme (MCS) of the payload indicated in the header. For example, a receiving node may bypass attempting to decode a payload of a packet in response to a measure of a signal strength of a decoded header of the packet being below a threshold. The measure of the signal strength of the decoded header may be a signal-to-interference-plus-noise ratio (SINR) for the decoded header at the receiving node. The SINR for the decoded header may be used to estimate the SINR for the payload of the packet when encoded at a rate indicated in the decoded header of the packet. The threshold can be set to a threshold SINR that represents the minimum SINR required for the receiving node to successfully decode the payload of the packet when the payload is encoded at the indicated rate. Bypassing decoding of the payload of a packet when the estimated SINR for the payload is less than the threshold SINR allows the receiving node to detect headers of other packets that may arrive during the time interval that the receiving node would have spent decoding the payload of the packet. The likelihood that a packet addressed to the receiving node is missed because of a collision with a packet from a hidden node may therefore be reduced because packets from the hidden nodes are typically received at lower signal strengths than packets that are addressed to the receiving node.

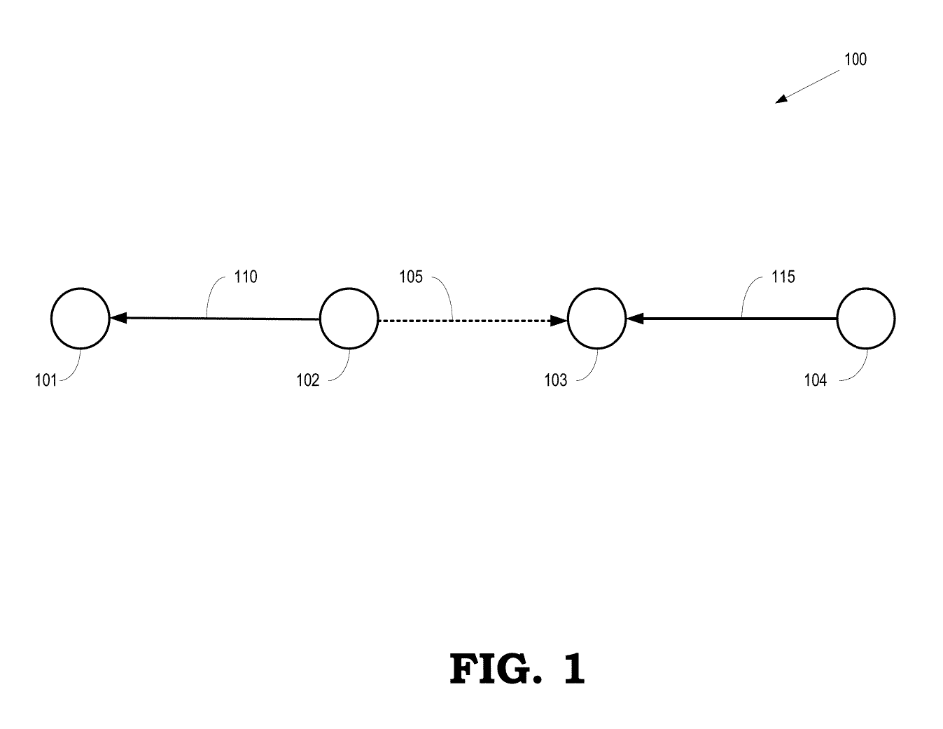

FIG. 1 is a diagram of a first example of a wireless communication system 100 according to some embodiments. The wireless communication system 100 includes a plurality of wireless communication nodes 101, 102, 103, 104 (collectively referred to herein as “the nodes 101-104”). Embodiments of the nodes 101-104 may be wireless transceivers such as access points or stations. For example, the nodes 101, 103 may be wireless access points and the nodes 102, 104 may be stations such as mobile units, mobile terminals, user equipment, access terminals, and the like. Nodes 102 and 104 may be hidden from each other due to their separation or due to obstructions (not shown in FIG. 1) that are interposed between the nodes 102 and 104. However, signals transmitted by the node 102 may be received by the node 103, as indicated by the dotted line 105. The nodes 102 and 103 may therefore be referred to as being within an “interference range” of each other.

In the illustrated embodiment, the node 102 is associated with the node 101 and is attempting to communicate with the node 101 by transmitting packets, as indicated by the arrow 110. For example, the node 102 may have registered for Wi-Fi communications with the node 101 according to the 802.11 standards. The transmitted packets may also be received at the node 103 because the nodes 102, 103 are within each other's interference range. The node 102 may not be associated with the node 103, e.g., because the node 102 has not registered for Wi-Fi communications with the node 103. The node 104 is associated with the node 103, e.g., because the node 104 has registered for Wi-Fi communications with the node 103. The node 104 may therefore be transmitting packets intended for reception by the node 103, as indicated by the arrow 115.

The node 103 may begin decoding packets transmitted by either the node 102 or the node 104, depending on the relative arrival times of packets from the nodes 102, 104. For example, the node 103 may begin decoding a packet transmitted by the node 104 if the node 103 is not currently decoding any packets and detects a preamble for the packet transmitted by the node 104. The node 103 first attempts to decode the header of the packet and, if successful, attempts to decode the payload of the packet using information such as the modulation and coding scheme (MCS) used to encode the payload of the packet. The MCS may be indicated in the decoded header of the packet. The node 103 may not attempt to decode any packets concurrently with decoding the packet transmitted by the node 104. Since the node 104 is associated with the node 103, the transmitted packet may be referred to as a “desired” packet since the packet is intended to be received by the node 103.

In some cases, the node 103 may begin decoding a packet transmitted by the node 102 if this packet arrives before a packet transmitted by the node 104. As discussed herein, the node 103 is not aware that the packet transmitted by the node 102 is not intended to be received by the node 103 (since the destination information may be included in the payload of the packet, which may be channel coded) and may therefore begin decoding the header of the packet. Some standards require that the node 103 attempt to decode the payload of the packet if it successfully decodes the header of the packet, regardless of whether or not the packet is intended to be received by the node 103. Consequently, as discussed herein, other packets such as packets transmitted by the node 104 may be missed, lost, or dropped if they are received concurrently with the node 103 decoding the packet transmitted by the node 102. For example, if the node 103 is decoding the payload of a packet received from the node 102 when a packet arrives from the node 104, the node 103 may be busy and unable to attempt to decode the packet from the node 104. The node 104 may therefore have to retry the transmission repeatedly until the node 102 stops transmitting or the packet transmitted by the node 104 arrives at the node 103 before the packet transmitted by the node 102. This may delay reception of packets transmitted by the node 104 and cause the node 103 to become “starved” because it is unable to receive the packets that it is intended to receive.

Some embodiments of the node 103 therefore implement selective decoding of payloads of received packets based on a measured signal strength of a decoded header of the packet and the MCS of the payload, which may be indicated in the header of the packet. For example, the node 103 can use information such as pilot signals in the header to measure the signal strength of the header of a received packet if the node 103 successfully decodes the header of a packet. The node 103 can also identify the MCS of the payload using information included in the decoded header. The measured signal strength of the header can be used to estimate or predict the signal strength of the payload of the packet and the MCS of the payload can be used to estimate a threshold signal strength at or above which the node 103 can successfully decode the payload of the packet. If the measured signal strength of the header exceeds the threshold signal strength, the node 103 attempts to decode the payload of the packet. However, if the measured signal strength of the header is less than the threshold signal strength, the node 103 bypasses attempting to decode the payload of the packet.

Hidden nodes are more likely to have lower signal strengths at the receiving node (relative to nodes transmitting information intended for the receiving node) and consequently selective decoding of the payloads of received packets allows the receiving node to preferentially decode payloads of packets that are intended to be received at the receiving node. For example, the estimated signal strength of a payload of a packet transmitted from the hidden node 102 to the receiving node 103 is more likely to fall below the signal strength threshold than a corresponding packet transmitted from a node 104 that is associated with the receiving node 103. Thus, even if the packet from the hidden node 102 arrives at the receiving node 103 before a packet from the node 104, the receiving node 103 may bypass attempting to decode the payload of the packet from the hidden node 102, thereby reducing the time interval that the node 103 spends decoding the packet from the hidden node 102 and making it more likely that the node 103 is able to receive packets from its associated node 104.

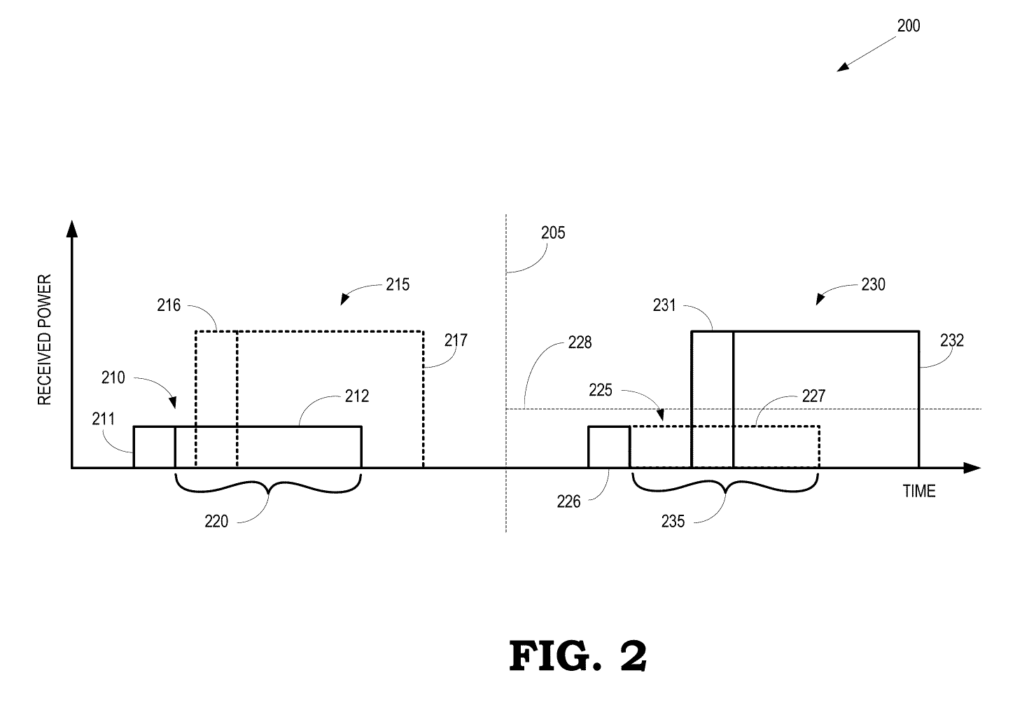

FIG. 2 is a plot 200 that illustrates interference between packets received at a receiving node from different transmitting nodes according to some embodiments. The vertical axis indicates the received power in arbitrary units and the horizontal axis indicates time increasing from left to right. The receiving node does not implement or perform selective decoding of packet payloads when receiving packets to the left of the dashed line 205. Packet 210 is transmitted by a first transmitting node that is hidden from a second transmitting node that transmits a packet 215. The packet 210 includes a header 211 and a payload 212; the packet 215 includes a header 216 and a payload 217. The receiving node successfully decodes the header 211. Since the receiving node does not implement or perform selective decoding of packet payloads, the receiving node then attempts to decode the payload 212. The receiving node is occupied by decoding the payload 212 during the time interval 220. The packet 215 arrives during the time interval 220 and so the receiving node is unable to attempt to decode the packet 215 (as indicated by the dotted lines), even though the signal strength of the packet 215 is larger than the signal strength of the packet 210.

The receiving node implements and performs selective decoding of packet payloads when receiving packets to the right of the dashed line 205. Packet 225 is transmitted by a first transmitting node that is hidden from a second transmitting node that transmits a packet 230. The packet 225 includes a header 226 and a payload 227; the packet 230 includes a header 231 and a payload 232. The receiving node successfully decodes the header 226. The receiving node measures the signal strength of the decoded header 231 and retrieves information indicating the MCS used to encode the payload 227 from the decoded header. The receiving node then estimates the signal strength (at the receiving node) of the payload 227 and determines a threshold signal strength (indicated by the dashed line 228) for decoding the payload 227 based on the MCS. In this example, the receiving node compares the estimated payload signal strength to the threshold signal strength 228 and determines that the estimated payload signal strength for the payload 227 is below the threshold signal strength 228. The receiving node therefore bypasses the attempt to decode the payload 227 (as indicated by the dotted lines), thereby leaving the receiving node able to receive signals during the time interval 235 that would otherwise have been occupied decoding the payload 227. The packet 230 arrives during the time interval 235 and the receiving node is able to attempt to decode the packet 230 because the receiving node is not occupied decoding the payload 227.

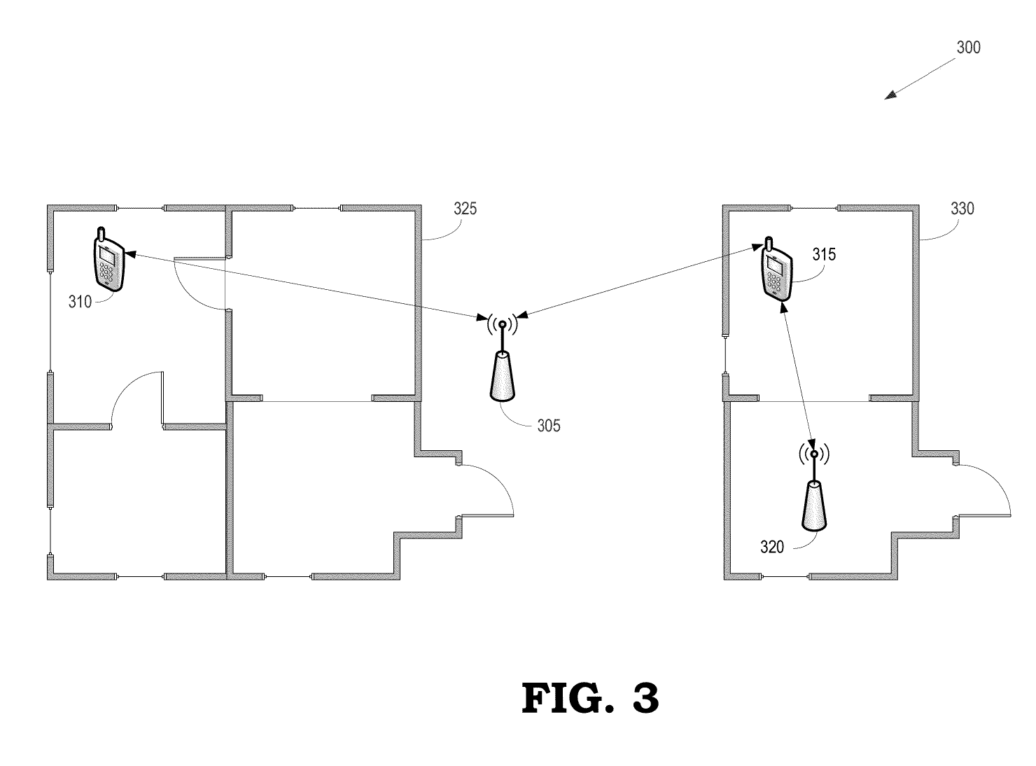

FIG. 3 is a diagram of a second example of a wireless communication system 300 according to some embodiments. In the illustrated embodiment, an access point 305 is used to provide wireless connectivity to a corresponding geographic area or cell, which may include station 310 that is associated with the access point 305 and one or more stations 315 that are not associated with the access point 305. The wireless communication system 300 may also include one or more other access points 320 that are used to provide wireless connectivity to a corresponding geographic area or cell, which may include the station 315. As used herein, the term “access point” is understood to refer to a node or a device that provides wireless connectivity to the stations 310, 315 or other nodes within a corresponding geographic area. The term “access point” may therefore encompass base stations, base station routers, eNodeBs, macrocells, microcells, femtocells, picocells, and other types of devices. For example, the access points 305, 320 may provide wireless connectivity according to Wi-Fi standards, 3GPP standards, IEEE 802 standards, or other communication standards. In some embodiments, the access points 305, 320 or the stations 310, 315 may correspond to one or more of the nodes 101-104 shown in FIG. 1.

Buildings 325, 330 may be located within one or more of the geographic areas served by the access points 305, 320. As discussed herein, obstructions such as the doors, windows, or walls of the buildings 325, 330 may significantly increase channel loss between the stations 310, 315 and the access points 305, 320. Exemplary building penetration losses are typically on the order of 11-20 dB. For a given transmission power, the penetration losses may make it difficult or impossible for the stations 310, 315 to detect each other's presence. The stations 310, 315 may therefore be hidden from each other. Uplink transmissions from the station 310 that are intended to be received by the access point 305 may not be received at the access point 305 if the access point 305 is occupied attempting to decode portions of a previously received packet from the hidden station 315, as discussed herein. Some embodiments of the access point 305 may therefore implement and perform selective decoding of packet payloads based on the measured signal strength of the packet header and the MCS for the packet payload indicated in the packet header, as discussed herein. Downlink transmissions from the access points 305, 320 may also collide at receiving nodes such as the station 315. Some embodiments of the station 315 may therefore implement and perform selective decoding of packet payloads based on the measured signal strength of the packet header and the MCS for the packet payload indicated in the packet header, as discussed herein.

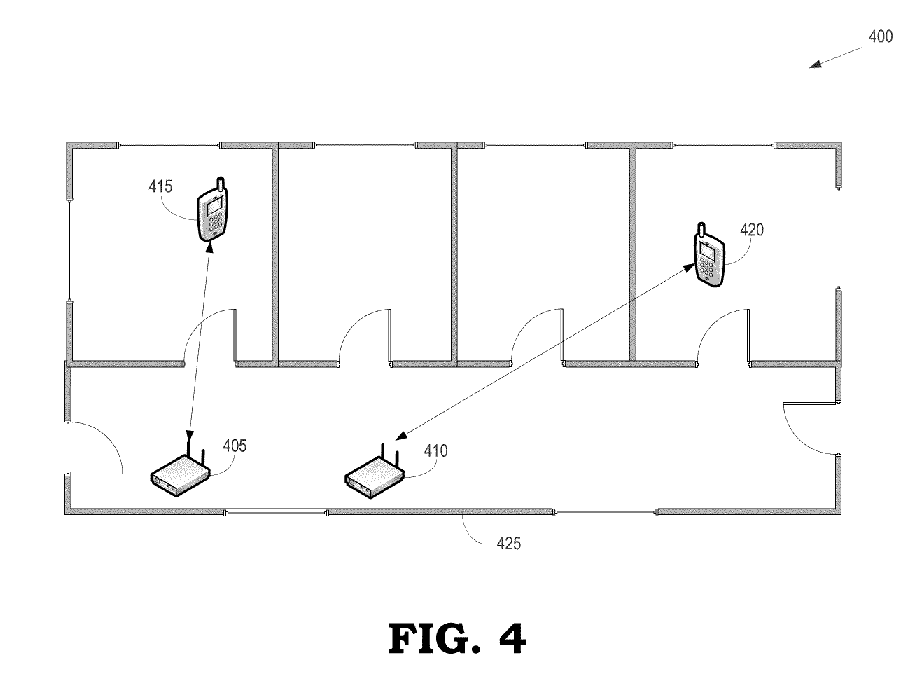

FIG. 4 is a diagram of a third example of a wireless communication system 400 according to some embodiments. In the illustrated embodiment, access points 405, 410 are used to provide wireless connectivity to corresponding geographic areas or cells, which may include stations 415, 420. For example, the access point 405 may be associated or registered with the station 415 and the access point 410 may be associated or registered with the station 420. The access points 405, 410 and the stations 415, 420 are deployed within a building 425 such as an office building. The station 415 shown in FIG. 4 is physically closer to the access point 410 than the station 420. Consequently, signals from the station 415 may arrive at the access point 410 concurrently with signals from the station 420. In some embodiments, the access points 405, 410 or the stations 415, 420 may correspond to one or more of the nodes 101-104 shown in FIG. 1.

The access point 410 may become starved for signals from the station 420 if packets from the station 415 arrive before packets from the station 420, e.g., within a particular contention window. Some embodiments of the access point 410 therefore implement and perform selective decoding of packet payloads based on the measured signal strength of the packet header and the MCS for the packet payload indicated in the packet header, as discussed herein. Downlink transmissions from the access points 405, 410 may also collide at receiving nodes such as one or more of the stations 415, 420. Some embodiments of the stations 415, 420 may therefore implement and perform selective decoding of packet payloads based on the measured signal strength of the packet header and the MCS for the packet payload indicated in the packet header, as discussed herein.

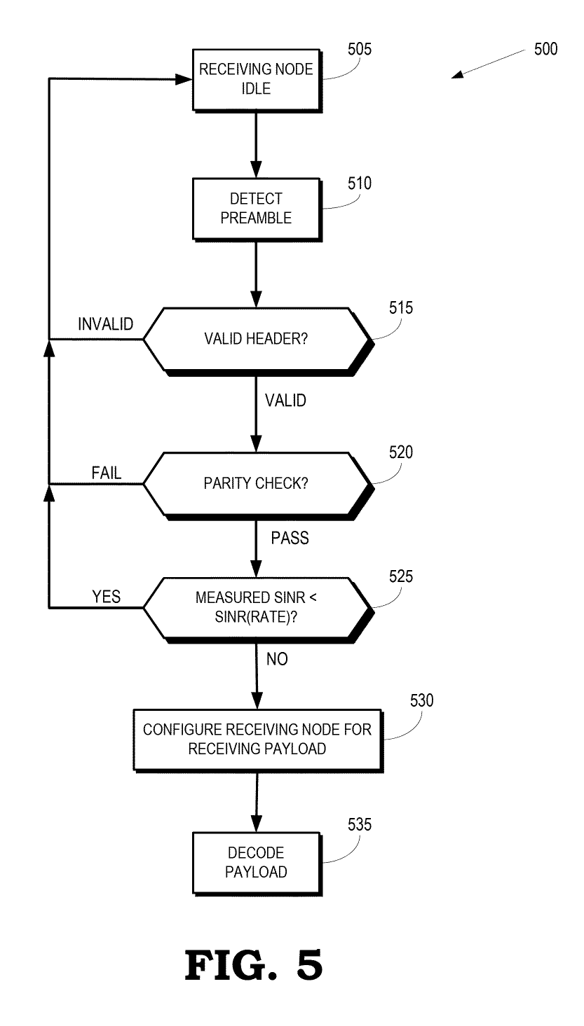

FIG. 5 is a flow diagram of a method 500 for selectively decoding packet payloads at a receiving node according to some embodiments. The method 500 may be implemented in some embodiments of nodes such as the nodes 101-104 shown in FIG. 1. At block 505, the receiving node is idle and awaiting signals from one or more nodes. At block 510, the receiving node detects a preamble transmitted by a transmitter node. At decision block 515, the receiving node attempts to decode the header of a packet transmitted by the transmitter node and then assesses whether the header is valid. Some embodiments of the receiving node may assess the validity of the header of the packet according to the requirements of the 802.11 standard. If the header is invalid, the receiving node may bypass decoding of the header of the packet and return to the idle state at block 505. If the receiving node successfully decodes the header and determines that the header is valid, the receiving node may perform a parity check at decision block 520. For example, the receiving node may compare the value of a parity bit in the decoded header to the value of a parity bit calculated using the bits in the decoded header. If the parity check fails, the receiving node returns to the idle state at block 505.

At decision block 525, the receiving node compares a measured signal-to-interference-plus-noise ratio (SINR) associated with the packet header to a threshold SINR that is determined based on the packet payload MCS indicated in the packet header. The packet payload MCS may also be referred to as the packet payload RATE because the MCS indicates the coding rate used to encode the packet payload. The measured and threshold SINRs may be considered indicators of corresponding measured and threshold signal strengths such as discussed herein with regard to FIG. 1. The SINR associated with the packet header may be measured using pilots or other reference signals that may be transmitted in conjunction with or as part of the packet header.

Some embodiments of the receiving node perform the comparison at decision block 525 by estimating the SINR for the packet payload based on the measured SINR of the packet header and comparing the estimated packet payload SINR to a threshold SINR that indicates a SINR that may be necessary for decoding the packet payload at the receiving node. Some embodiments of the receiving node may alternatively perform the comparison at decision block 525 by comparing the measured SINR of the packet header to a threshold SINR that indicates that the subsequently received packet payload should be successfully decoded if the measured SINR of the packet header exceeds the threshold SINR. The threshold SINR may be determined as a function of the measured SINR, a length of the packet payload, channel conditions or channel quality information associated with one or more propagation channels used to convey the packet header or packet payload, or the MCS of the packet header or the packet payload. Examples of characteristics of the propagation channels that may indicate channel conditions or channel quality include a measured signal strength, a frequency selectivity, a delay spread, or a Doppler spread. In some embodiments, a table may be used to store values of the threshold SINR as a function of the MCS or RATE used to encode the packet payload.

The receiving node selectively decodes the packet payload based on the comparison in decision block 525. The receiving node bypasses decoding of the packet payload if the measured or estimated SINR is less than the threshold SINR(RATE). The receiving node may then return to the idle state at block 505 to await subsequent transmissions. The receiving node attempts to decode the packet payload if the measured or estimated SINR is greater than the threshold SINR(RATE). At block 530, the receiving node is configured to receive the packet payload. For example, the demodulation type and the coding rate used by the receiving node may be configured or modified based on information included in the decoded packet header. At block 530, the configured receiving node decodes the packet payload.

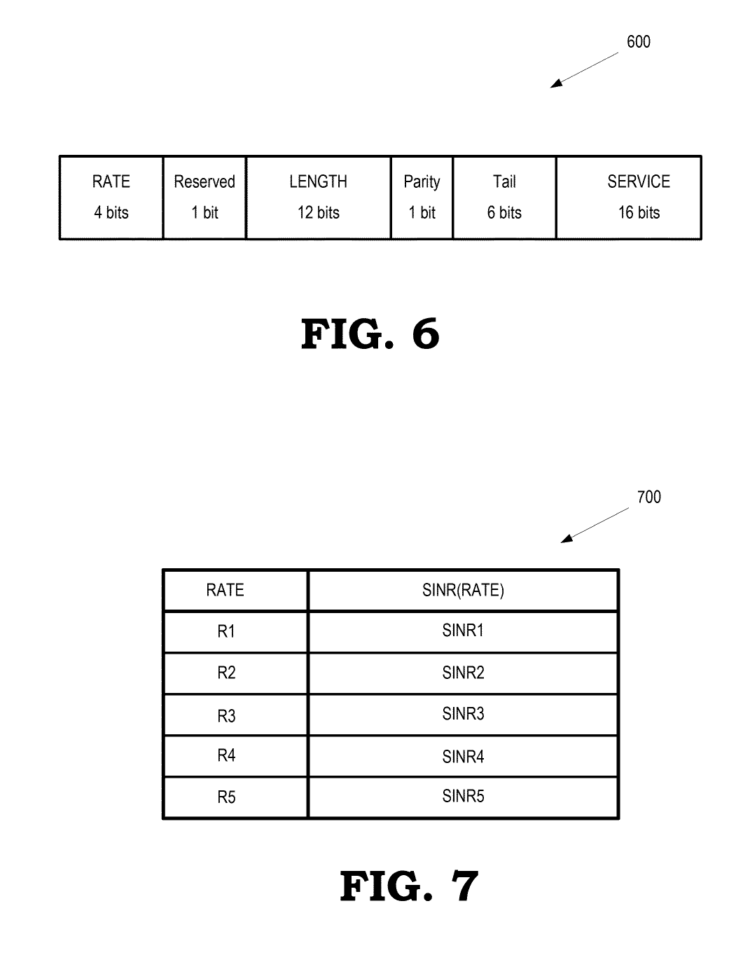

FIG. 6 is a diagram of a packet header 600 according to some embodiments. The packet header 600 includes a 4-bit field (RATE) to convey information indicating a modulation and coding scheme (MCS) for encoding rate used by an associated packet payload. A 1-bit field is Reserved for other uses. The packet header 600 also includes a 12-bit field (LENGTH) that is used to indicate the length of the subsequent payload and a parity bit that can be used to perform a parity check of the information received in the packet header. The packet header 600 also includes 6-bits in the Tail field and 16-bits in the SERVICE field, which may be used to initiate changes in the encoding rate, e.g., according to the 802.11 standards.

FIG. 7 is a diagram of a table 700 for storing values of a threshold SINR as a function of an encoding rate (RATE) according to some embodiments. The table 700 includes one column for storing the available coding rates (R1, R2, R3, R4, R5, R6) that may be used to encode packet payloads. Examples of coding rates that may be used to encode packet payloads include ½ binary phase shift keying (BPSK), ½ quadrature phase shift keying (QPSK), ¾ QPSK, ½ quadrature amplitude modulation (QAM), ⅔ QAM, ⅚ QAM, and the like. The table 700 includes another column for storing the threshold SINR corresponding to each of the available coding rates (SINR1, SINR2, SINR3, SINR4, SINR5, SINR6). The table 700 may be generated by nodes (or generated by a central network entity and provided to the nodes) and stored in a data structure in the nodes. As discussed herein, the threshold SINRs may be determined as a function of a measured SINR, a length of the packet payload, channel conditions or channel quality information associated with one or more propagation channels used to convey the packet header or packet payload, or the MCS of the packet header or the packet payload. The node can then access the table 700 using the rate indicated in the packet header to identify the appropriate threshold SINR for deciding whether to decode the packet payload.

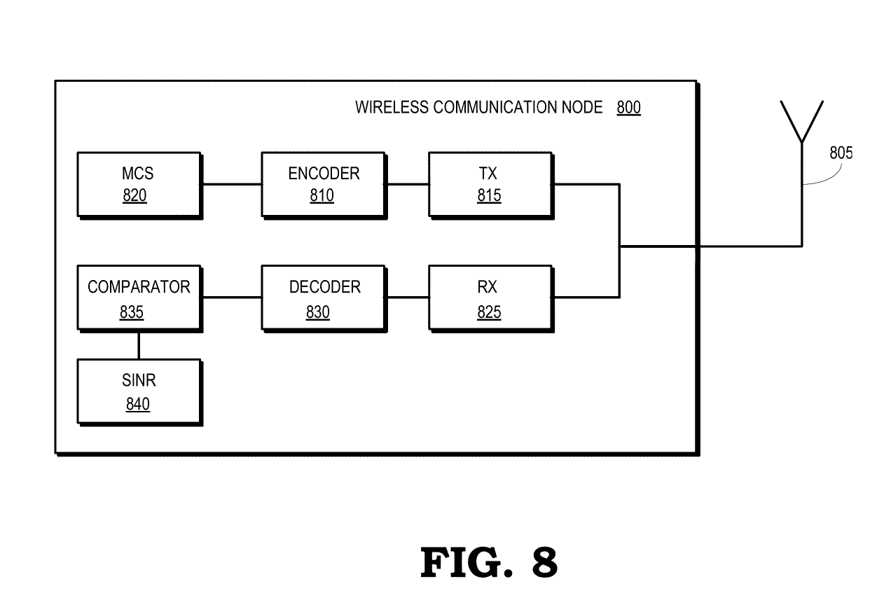

FIG. 8 is a block diagram of a wireless communication node 800 according to some embodiments. The wireless communication node 800 may be implemented as one or more of the nodes 101-104 shown in FIG. 1, the nodes 305, 320 shown in FIG. 3, or the nodes 405, 410 shown in FIG. 4. The wireless communication node 800 includes one or more antennas 805 that are used to transmit or receive radio frequency signals over an air interface. An encoder 810 is used to encode signals for transmission by transmission logic (TX) 815. The encoder 810 may encode signals using an MCS provided by MCS logic 820.

Receive logic 825 may be used to receive radiofrequency signals from the antenna 805. The radiofrequency signals may be representative of one or more packets transmitted over the air interface. Some embodiments of the wireless communication node 800 may include a decoder 830 for selectively decoding payloads of the packets based on a measured signal strength of a decoded header of the packet and an MCS used to encode the payload of the packet. For example, the wireless communication node 800 may include a comparator 835 that can compare a signal strength of a decoded header to a threshold signal strength, which may be provided by SINR logic 840 in the form of a threshold SINR value. The decoder 830 may then selectively decode the payload of the packet depending on whether the measured signal strength of the decoded header is greater than or less than the threshold signal strength, as discussed herein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selectively decoding a payload of a packet based on a measured signal strength of a decoded header of the packet and a modulation and coding scheme (MCS) used to encode the payload of the packet.

2. The method of claim 1, wherein the MCS used to encode the payload of the packet is indicated in the decoded header of the packet.

3. The method of claim 1, further comprising:
estimating a signal strength of the payload of the packet based on the measured signal strength of the decoded header of the packet.

4. The method of claim 3, further comprising:
bypassing an attempt to decode the payload of the packet in response to the estimated signal strength of the payload being less than a threshold signal strength; and
attempting to decode the payload of the packet in response to the estimated signal strength of the payload being greater than the threshold signal strength.

5. The method of claim 4, further comprising:
determining the threshold signal strength based on the MCS used to encode the payload of the packet.

6. The method of claim 1, wherein selectively decoding the payload of the packet based on the measured signal strength of the decoded header comprises selectively decoding the payload of the packet based on a measured signal-to-interference-plus-noise ratio (SINR) of the decoded header.

7. The method of claim 6, further comprising:
determining each of a plurality of threshold SINRs for each of a plurality of MCSs available for encoding the payload of the packet based on at least one of the measured SINR of the decoded header of the packet, a length of the payload, or an estimate of at least one propagation channel used to transmit the payload of the packet.

8. The method of claim 7, further comprising:
selecting one of the plurality of threshold SINRs based on the MCS used to encode the payload of the packet; and
comparing the selected threshold SINR to an estimated SINR of the payload of the packet, wherein the estimated SINR is estimated based on the measured SINR of the header of the packet.

9. The method of claim 8, further comprising:
bypassing an attempt to decode the payload of the packet in response to the estimated SINR being less than the selected threshold SINR; and
attempting to decode the payload of the packet in response to the estimated SINR being greater than the selected threshold SINR.

10. A wireless communication node to selectively decode a payload of a packet based on a measured signal strength of a decoded header of the packet and a modulation and coding scheme (MCS) used to encode the payload of the packet.

11. The wireless communication node of claim 10, wherein the wireless communication node is to estimate a signal strength of the payload of the packet based on the measured signal strength of the decoded header of the packet.

12. The wireless communication node of claim 11, wherein the wireless communication node is to:
bypass an attempt to decode the payload of the packet in response to the estimated signal strength of the payload being less than a threshold signal strength; and
attempt to decode the payload of the packet in response to the estimated signal strength of the payload being greater than a threshold signal strength.

13. The wireless communication node of claim 12, wherein the wireless communication node is to determine the threshold signal strength based on the MCS used to encode the payload of the packet.

14. The wireless communication node of claim 10, wherein the wireless communication node is to selectively decode the payload of the packet based on a measured signal-to-interference-plus-noise ratio (SINR) of the decoded header.

15. The wireless communication node of claim 14, wherein the wireless communication node is to determine each of a plurality of threshold SINRs for each of a plurality of MCSs available for encoding the payload of the packet based on at least one of the measured SINR of the decoded header of the packet, a length of the payload, or an estimate of at least one characteristic of a propagation channel used to transmit the payload of the packet.

16. The wireless communication node of claim 15, wherein the wireless communication node is to:
select one of the plurality of threshold SINRs based on the MCS used to encode the payload of the packet; and
compare the selected threshold SINR to an estimated SINR of the payload of the packet, wherein the estimated SINR is estimated based on the measured SINR of the header of the packet.

17. The wireless communication node of claim 16, wherein the wireless communication node is to:
bypass an attempt to decode the payload of the packet in response to the estimated SINR being less than the selected threshold SINR; and
attempt to decode the payload of the packet in response to the estimated SINR being greater than the selected threshold SINR.

18. The wireless communication note of claim 16, wherein the wireless communication node is at least one of an access point or a station.

19. A non-transitory computer readable medium embodying a set of executable instructions, the set of executable instructions to manipulate at least one processor to:
selectively decode a payload of a packet based on a measured signal strength of a decoded header of the packet and a modulation and coding scheme (MCS) used to encode the payload of the packet.

20. The non-transitory computer readable medium of claim 19, embodying a set of executable instructions to manipulate the at least one processor to:
bypass an attempt to decode the payload of the packet in response to an estimated signal strength of the payload being less than a threshold signal strength; and
attempt to decode the payload of the packet in response to an estimated signal strength of the payload being greater than a threshold signal strength.
